(19) United States
(12) Patent Application Publication
(10) Pub. No.: US 2014/0229199 A1
(43) Pub. Date: Aug. 14, 2014

(54) SYSTEM AND METHOD FOR DYNAMIC AND CUSTOMIZED QUESTIONNAIRE GENERATION

(71) Applicant: Keith Beckley, King City (CA)

(72) Inventor: Keith Beckley, King City (CA)

(73) Assignee: TIMEWYSE CORPORATION, Richmond Hill, ON (CA)

(21) Appl. No.: 14/128,333

(22) PCT Filed: Jun. 20, 2012
(86) PCT No.: PCT/CA2012/050409

§ 371 Date: Apr. 9, 2014

Related U.S. Application Data
(60) Provisional application No. 61/498,990, filed on Jun. 20, 2011.

(51) Int. Cl. G06F 19/00

(52) U.S. Cl. CPC G06F 19/363
USPC 705/3

(57) ABSTRACT

Embodiments disclosed herein provide systems and methods for the customization of a questionnaire according to entity-specific data. A set of questions are customized according to customization logic that references entity-specific data. Information identifying the entity and identifying a database including the entity-specific data is combined with a reference from the customization logic to generate a query to the database for obtaining the entity-specific data. The entity-specific data, set of questions, and customization logic are then processed to render the customized questionnaire. The customization logic may employ an intermediate reference, where an interface table provides an interface between the reference and the location of the entity specific data, or optionally a query for obtaining the entity-specific data.

### CROSS-REFERENCE TO RELATED APPLICATION

This application claims priority to U.S. Provisional Application No. 61/498,990, titled “SYSTEM AND METHOD FOR DYNAMIC AND CUSTOMIZED QUESTIONNAIRE GENERATION” and filed on Jun. 20, 2011, the entire contents of which are incorporated herein by reference.

### BACKGROUND

This disclosure relates to systems and methods of generating questionnaires. More particularly, the present disclosure relates to the generation of customized questionnaires for use with electronic medical record systems.

The computerization of questionnaires provides numerous benefits, including significant efficiencies and cost savings in designing and delivering computerized questionnaires as compared to their paper-based predecessors. When offered in a networked environment, such as through a web browser, computer-based questionnaires can be highly useful in efficiently collecting data from a large number of recipients over a wide geographical area.

The utility of computer-based questionnaires is known to be significantly enhanced by a branched logical hierarchy, in which the logical flow of questions presented during the rendering of a computerized questionnaire is influenced by answers to preceding questions in the questionnaire.

Unfortunately, many questionnaire systems, while supporting some degree of user-specific modification, fail to provide the degree of customization that is beneficial for different applications, such as patient-specific clinical questionnaires.

### SUMMARY

Embodiments disclosed herein provide systems and methods for the customization of a questionnaire according to entity-specific data. A set of questions are customized according to customization logic that references entity-specific data. Information identifying the entity and identifying a database including the entity-specific data is combined with a reference from the customization logic to generate a query to the database for obtaining the entity-specific data. The entity-specific data, set of questions, and customization logic are then processed to render the customized questionnaire. The customization logic may employ an intermediate reference, where an interface table provides an interface between the reference and the location of the entity specific data, or optionally a query for obtaining the entity-specific data.

Accordingly, in a first aspect, there is provided a computer implemented method of generating a customized questionnaire, wherein the customized questionnaire is customized for an entity, the method comprising the steps of: retrieving a set of questions; retrieving customization logic associated with the customized questionnaire for customizing the set of questions according to entity-specific data, wherein the customization logic comprises a reference for obtaining the entity-specific data from a database; employing the reference to generate a query for obtaining the entity-specific data from the database; receiving the entity-specific data in response to the query; and processing the customization logic and the entity specific data to render the customized questionnaire.

In another aspect, there is provided a computer readable medium storing computer executable instructions for causing a computer to perform a method of generating a customized questionnaire, wherein the customized questionnaire is customized for an entity, comprising the steps of: retrieving a set of questions; retrieving customization logic associated with the customized questionnaire for customizing the set of questions according to entity-specific data, wherein the customization logic comprises a reference for obtaining the entity-specific data from a database; employing the reference to generate a query for obtaining the entity-specific data from the database; receiving the entity-specific data in response to the query; and processing the customization logic and the entity specific data to render the customized questionnaire.

In another aspect, there is provided a system for providing a customized questionnaire, said system comprising: a storage device comprising a set of questions; one or more processors; and memory coupled to the one or more processors, the memory storing instructions including customization logic associated with the customized questionnaire for customizing the set of questions according to entity-specific data, wherein the customization logic comprises a reference for obtaining the entity-specific data from a database, and wherein the instructions, when executed by the one or more processors, cause the one or more processors to perform operations comprising: retrieving the set of questions from the storage device; employing the reference to generate a query for obtaining the entity-specific data from the database; receiving the entity-specific data in response to the query; and processing the customization logic and the entity-specific data to render the customized questionnaire.

In another aspect, there is provided a system for providing a customized questionnaire, said system comprising: a storage device comprising a set of questions; a processor; and a memory coupled with the processor, the memory comprising a computer readable medium having a questionnaire rendering engine embodied therein, said questionnaire rendering engine comprising customization logic for the customization of the customized questionnaire according to entity-specific data.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 schematically illustrates the main components of a system for generating and coding.

FIG. 2 provides a flow chart illustrating a method of providing an entity-specific record linked dynamic questionnaire.

FIG. 3 provides a schematic illustrating an embodiment in which the system may be implemented on a computing device.

FIG. 4 schematically illustrates a client-server system for dynamically generating questionnaires based on a record associated with an entity.

FIG. 5 illustrates another embodiment of a client-server system for the dynamic generation and customization of a questionnaire based on records stored in a database.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure. It should be understood that the order of the steps of the methods disclosed herein is immaterial so long as the methods remain operable. Moreover, two or more steps may be conducted simultaneously or in a different order than recited herein unless otherwise specified.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

As used herein, the term “questionnaire” shall mean any survey, test, assessment, or other set of questions.

As used herein, the term “database” shall mean any collection of data stored together and organized for search and retrieval, including, without limitation, flat file databases, fielded databases, full-text databases, object-oriented databases, and relational databases.

As used herein, the term “customization logic” refers to logic that is employed for the customization of a questionnaire based on data in a record associated with an entity. Customization logic may, in some embodiments, refer to custom branching logic that customizes the sequential presentation of questions. In other examples, customization logic may be employed for the customization of the scheduling, creation, and/or display format of a questionnaire. Customization logic may additionally or alternatively be employed to customize the processing of questionnaire results, or the storing or archiving of questionnaire results.

As used herein, the term “entity” refers to a person, individual, group of people, group of people including a given individual of interest, organization, company, or other group, collective, association, to whom or to which data for customization of a questionnaire is associated. The entity may be the user completing a given questionnaire, such as a patient completing a medical questionnaire related to his or her medical record. In other embodiments and examples, the user completing a customized questionnaire need not be the entity to which the questionnaire is customized. For example, the user may be a physician completing a questionnaire associated with a patient under the physician's care, where the questionnaire is customized based on the patient record.

Embodiments disclosed herein provide systems and methods for generating a questionnaire with customization logic that is determined according to a record associated with an entity. Selected embodiments further support the two-way transfer of data between a user device and a database storing a record for updating a record according to information obtained via the questionnaire. Additional embodiments provide systems and methods for the creation of dynamic questionnaires based on customization logic linked (e.g. via a reference) to a record associated with an entity. In other embodiments, methods of dynamically rendering entity-specific questions are provided, in which the form of the question is determined according to data stored in a record associated with an entity.

Unlike known methods in which the logical flow of questions is dictated by the answers to previous, embodiments disclosed below utilize information obtained from an entity-specific record for the customization of a questionnaire.

In some implementations, the record may be any form of data that relates to an entity. For example, the entity may be a patient, and the record may be an electronic patient record that is stored in a physical memory or media. In one example, the data may be provided by the patient, such as data recorded about an activity that the patient has been asked to monitor, or data which the patient has entered under his or her own volition). In other non-limiting examples, the record may include other forms of data relating to an entity, such as employment data, educational data, financial data, social data and/or behavioral data.

The record may be stored in any suitable computer-readable format. For instance, according to several non-limiting examples, the record may be stored electronically, magnetically, optically or physically; it may be kept in plaintext format, in a coded numerical scheme or in an encrypted format; and it may be stored in a database, in a tagged markup language for data storage, in an ordered list or in a collection of files.

Although the present disclosure provides embodiments in which an entity-customized questionnaire is provided according to customization logic based on a record associated with an entity, it is to be understood that the questionnaire need not be executed or completed by the entity. For example, the questionnaire may be executed or completed by one or more individuals having a relationship to the entity, such as a physician or other health care provider completing a questionnaire relating to, or on behalf of, a patient.

Data stored in a record, which is obtainable via a reference provided in the customization logic, may be employed according to various embodiments for the generation of an entity-customized questionnaire. As described further below, data may be utilized in several different ways for the customization of a questionnaire, such as, controlling the logical branching or displaying of questions, or customizing the determination or selection of the possible answers to be displayed in association with the questions, and other methods disclosed below. The data from the entity-specific record may be obtained during the execution of a questionnaire, or may additionally or alternatively be obtained prior to the execution of a questionnaire.

The customization logic may include branching logic that determines the ordering of presented questions according to the record and further optionally the answers to previous questions or previous questionnaires. The customization logic may also determine an appropriate subset of questions to include from a larger set of questions, where the subset is determined according to the record. The customization logic may also incorporate random or pseudorandom elements, such as the random or pseudorandom determination, in whole or in part, of the ordering of questions and/or the questions selected to be included in a subset of questions for a given questionnaire.

In another embodiment, additional questions from one or more additional questionnaires may be included when rendering a first questionnaire, where the ordering and/or the customization of the additional questions is determined according to the customization logic (e.g. in a manner dependent on the data in the entity-specific record). Such an embodiment enables, for example, a first questionnaire to optionally include questions from a secondary questionnaire, thereby effectively imbedding another questionnaire into a first questionnaire. In some cases, only a subset of an additional questionnaire may be rendered according to customization logic, and/or the sequence of additional questions may be determined according to branching logic of the customization logic. Accordingly, the option of including one or more additional questions from another questionnaire may be dictated according to the customization logic. In some embodiments, customization logic (e.g. branching and/or visibility/presentation rules/logic) may dictate the presence, order and/or presentation format of additional questions according to the answers provided in the first questionnaire. This embodiment may be employed, for example, when it is deemed to be useful or relevant to optionally “dig” further in to a topic for which another questionnaire exists. The transition from the first questionnaire to providing questions from the additional questionnaire may be seamless and invisible to the user. For example, in some cases, in which the additional questionnaire is employed to obtain additional information on a given topic, the user may only perceive that more detailed questions are being asked.

In one example of such an embodiment, a patient may be asked to provide answers to an intake questionnaire at a doctor's office. The customization logic may determine the rendering of questions based on data in an entity-specific record, where the record includes some initial data obtained from the patient's health card. When compiling the intake questionnaire according to the customization logic, customized questions may be included from an additional questionnaire associated with a specific health condition, such as heart disease, if the patient is determined to fall within a selected demographic group based on the data in the entity-specific record, and/or answers provided in the intake questionnaire.

In another embodiment, the customization logic may determine whether or not a questionnaire is to be offered and/or scheduled, where the determination is made based on the data stored in the entity-specific record. For example, a questionnaire may only be made available or published when certain data elements in a record meet one or more conditions. A non-limiting example of this embodiment involves publishing a questionnaire to a patient whose health history meets selected criteria, such as indicating a high blood sugar result and a history or smoking.

In another embodiment, the customization logic may be employed for the future scheduling of a questionnaire based on the answers provided in previously completed questionnaire. For example, after a questionnaire has been completed, one or more additional questionnaires can be automatically scheduled for the entity, based on the answers provided in the completed questionnaire. The additional questionnaires may be the same as the completed questionnaire, or may be different from the completed questionnaire. The scheduling may relate to a single questionnaire, or may pertain to a questionnaire that is to be scheduled for completion on a repeat basis (for example, to be repeated after a prescribed time interval, or to be repeated on a periodic basis, such as every day, once a week, or every Tuesday). In one embodiment, the decision to schedule one or more future questionnaires may be dependent on the answers provided in a completed questionnaire and entity-specific data (e.g. age, address, marital status, gender).

In one non-limiting example, demographic information (such as gender, age, home location) can be used to control the presentation and customization logic of displayed questions. For example, if the entity is a patient and the record is an electronic medical record or electronic health record, then the customization logic may be determined according to the most recently recorded patient weight. In one example implementation, if a patient's most recently recorded weight is more than a particular value, then a set of questions are displayed relating to diet. Conversely, if the patient's weight was in a normal range, these questions are not included in the questionnaire. Additional forms of data in the patient record, such as the patient's age, could be combined with the patient's weight to further customize the presented questions.

In one embodiment, the customization logic may employ data in the record to control the presentation of questions in the questionnaire when displaying the questionnaire. The customization logic may, for example, determine the font size of all or a portion of a questionnaire, such as displaying questions in a font size dependent on data indicative of the entity's age, with a larger font provided for older (and/or younger) individuals. The font size could also be determined according to data indicative of impairment, or a known eyeglass prescription of the entity. In another example, the complexity of the questionnaire may be determined according to entity-specific data. For example, the reading grade level of a questionnaire may be determined based on the entity's age, or based on a cognitive impairment as recorded in the entity-specific data, where the customization logic drives the selection of an appropriate form of a question (from two or more forms with different reading levels) based on the entity-specific data.

The customization logic may be employed to control the inclusion of entity-customized content when presenting a given question of a questionnaire. The entity-customized content may include content that is displayed based on data in an entity-specific record, and/or may contain content from the data record. For example, a given question in a questionnaire may query a patient about his or her current medications. To assist the entity in recalling which medications the patient is currently taking, the question as presented may include check-boxes (or another suitable selection format) corresponding to a list of medications.

In one example, the list may contain a superset of medications that are related to known medications obtained from the patient record, where the known medications are those that the patient has taken in the past, and/or that the patient is expected to be currently taking, based on the patient-specific data. This list of known medications could be obtained from a single database or patient-specific record, or could be obtained from a separate database that is known to contain information related to the patient. For example, some of the patient-specific data may be obtained from an electronic health record controlled by the patient's physician, while other entity-specific data, such as some or all of the known medication list, may be obtained from a third party (e.g. government) database of past prescriptions associated with the patient. In another example, the list of medications may be a list of the known medications. The customization logic may also configure the user interface to provide an input means for inputting an additional or new medication, such as, for example, an expandable list of possible medications (optionally provided in an expandable tree structure), or simply an “other” field in which the entity may include additional medications that are not shown.

In another embodiment, the display of entity-specific information in a questionnaire may be determined by customization logic involving two or more elements of the entity-specific record. For example, if a patient is currently prescribed a certain set of medications and the patient record includes lab results satisfying selected criteria (such as criteria corresponding to a known disease state or health condition), then the customization logic may drive the presentation of a specific subset of questions, where the presentation of content in a given question is determined, at least in part, by the entity-specific data.

For example, a questionnaire may include a question relating to past episodes of depression. A suitable textual form for this question may be, “In the past, what has helped to mitigate your depression?” In addition to displaying this text associated with the question, the customization logic associated with this question may also instruct the computing system processing the questionnaire to access the patient-specific record and obtain a list of depression-related medications that are prescribed (or optionally have been prescribed) to the patient. If the patient-specific record does not include any depression-related medications, then no additional content is displayed. However, if the patient-specific record does include one or more depression-related medications, then the questions is displayed such that each depression-related medication is provided as a selectable answer to the question.

In addition to the present example of presenting entity-specific content in a question according to known medications associated with a medical condition, the presence of one or more medications associated with a medical condition may be employed to control the presence or absence of additional potential answers in the questionnaire. For example, in some questions, certain answers could be excluded if the query to the patient-specific record indicates that they a diagnosis of depression has not been made in a given time frame, such as the preceding 10 years.

In some embodiments, the customization logic may include permission rights determination for one or more questions of the questionnaire, based on an identity or user class of the entity, such that one or more questions of the questionnaire are displayed to a particular user/entity based on whether or not that entity has permission rights to view the question and/or provide an answer to the question. According to some embodiments, the permission rights may be associated with individual user/entity accounts, a collection of user/entity accounts, demographic information associated with the user/entity, and/or a user class. For example, in a healthcare setting, a doctor or other healthcare professional may be permitted, according to the type of user account, to view and optionally answer one subset of questions (e.g. every question of the questionnaire), while a patient may only have access to another subset of questions of the questionnaire. Accordingly, in one example implementation, one or more users/entities and/or user types may be assigned as ‘super users’ that has rights to a selected subset of questions, which may include every question of one or more questionnaires. Rights can either be explicitly given or taken away (global rights minus certain questions). The permission rights may be provided and encoded within the customization logic.

In many of the embodiments disclosed here, data pertaining to an entity associated with the questionnaire is obtained from a record, e.g. a record in a database. In some embodiments, data associated with the entity may additionally or alternatively be obtained from other data sources associated with the entity. For example, additional entity-specific data that may be employed by the customization logic when compiling/rendering a questionnaire may include data such as location information (e.g. GPS data or other location-based data), and/or data obtained from social media user accounts (e.g. twitter or e-mail posts). Such additional data may be obtained from a computing device associated with the entity, such as a mobile computing device (e.g. a smartphone). For example, a patient whose location is known to be a fitness club might be prompted to answer a fitness questionnaire with certain questions included or omitted based on keywords found in a patient's text messages.

The customization logic may be provided in the form of instruction steps of a computer program whereby data in the entity-specific record is quantified and/or compared to a reference value. For example, if the entity-specific record includes data elements in the form of a text string, then the comparison of the text string to a control or reference string value or set of values can be utilized to determine the logical flow of the questionnaire, such as the sequential order of questions.

The questionnaire questions and related customization logic may be coded in the form of questionnaire coding rules that provide computer readable instructions which may be executed by a processor for rendering the questionnaire. As further described below, the coding rules may be processed by a questionnaire rendering engine, which accesses the entity-specific record to render the questionnaire. In an example embodiment, the questionnaire coding rules are provided as instructions in the form of an Extensible Markup Language (XML) data. The coded rules may comprise a subset of a coded questionnaire or questionnaire rendering file.

In one embodiment, the coding of rules may employ embedded metatags for referencing entity-specific data within an entity-specific record. The metatags are an example of a reference to entity-specific data, that is to say, they may reference entity-specific data in a manner that does not depend on the implementation of the entity-specific data storage. For example, if patient data is stored in an SQL database, the metatags may contain queries or stored procedures which are able to reference the stored data; however, the metatags may be manipulated by the questionnaire rendering engine (described further below) using only their abstract names, such as “PatientLastVisit”. The metatag can be a reference containing a query for a certain set of data (for example a list of all previous patient visits for a particular doctor for a particular period). In this instance the metatag will reference a database query that returns the result (for example, a SQL stored procedure). Selection rules, based on those results, determine the action of the survey rendering engine.

Alternatively, a particular data element in the entity-specific record that is to be employed in the customization logic may be referenced in the coding rules by employing interface data, such as a separate interface table, whereby the reference is mapped, transformed, and/or translated, to the information for generating the database-specific query to obtain the actual value stored in the entity-specific record within the database. The metatag interface may thus consist of a database table, e.g. having rows, that relate the metatag to the entity-specific data. In the case of database-stored entity-specific records, this may be done through a database accessing language (SQL for instance), and in one implementation, one stored procedure is created to be generic and can access any discrete data element (name, age, patient number) from any table and return this data. In this specific example, the metatag is related to the table, column, and data type of the desired data.

An example implementation of an entry in the interface table is:

| TagID | TagName | Table Name | Field | Datatype | Data Access |
|---|---|---|---|---|---|
| 01 | PatientLastName | tPatientInfo | Surname | text | |
| 02 | PatientLastVisit | | | | spSelectLastVisits |

In this example the TagID 01 uses a query to retrieve the Patient last name based on the ‘Surname’ field in the ‘tPatientInfo’ table. TagID 02 will directly call the stored procedure spSelectlastVisit.

The use of an interface table provides a separation between the underlying database and the other components of the system. This architecture allows the questionnaire system to be able be ported easily to another database that may contain very different types of data. For a port to occur, the interface table is populated to map the data structure of the database to the metatags that the questionnaire user or programmer selects from. If desired, the underlying stored procedures may be updated to match the database. From a programmability standpoint and a portability standpoint, this affords a single point of contact between the entire questionnaire system and the database to which it is interfaced. As noted above, the software of the questionnaire engine does not have to change and the new metatags can be added by either the questionnaire programmer or the developer of the engine.

When retrieving entity-specific data from a record according to the example embodiments involving metatags, the rendering engine is provided with both a metatag and a form of entity identification. Although in many embodiments disclosed herein the rendering engine seeks data regarding only one entity, the rendering engine may create an entity-customized questionnaire using data from a number of entities. For example, in some embodiments, if no data for a specific entity is available, the data of entities determined to be of a “similar type” (e.g. same age, height, weight, prescribed medication) may be used and statistically processed (e.g. averaged, or weighted and averaged) to provide an estimate of what the missing data should be for the user completing the questionnaire.

Coding rules relating to data within an entity-specific record may dictate or prescribe rules relating to if and when a particular question is to be presented to a user performing a questionnaire, and/or may relate to how a given question or suggested answers to a given question are presented. Moreover, coding rules may relate to a particular question, set of questions or individual selectable answers to one or more individual questions. For example, in the context of an electronic medical questionnaire, a given question may ask “Where do you have pain?”, for which a set of potential answers are provided, for optional selection by the user, and where one or more of the potential answers are based on the entity-specific record. In this case, the set of potential answers would exclude the possible answer of ‘Breast’ for a male patient.

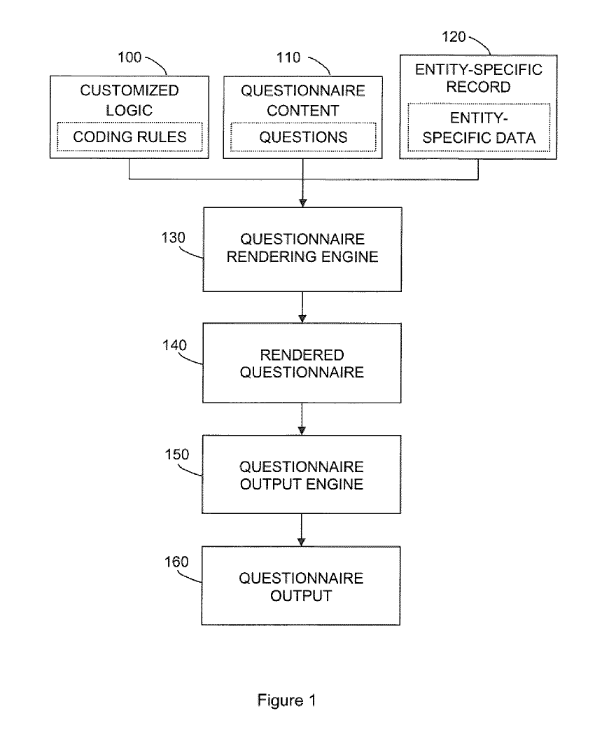

FIG. 1 illustrates a schematic of the main components of an example system for executing coding rules and presenting an entity-customized questionnaire to a user. Customization logic 100 (which includes coding rules), questionnaire content 110 (which contains questions to be asked), and entity-specific record 120 (which includes entity-specific data), are provided to questionnaire rendering engine 130, which renders an entity-customized questionnaire 140. Output engine 150 optionally processes the results of an executed or completed questionnaire to provide questionnaire output 160. Questionnaire rendering engine 130 may pre-process customized logic 100 (coding rules), questionnaire content 110, and entity-specific data 120 to prepare a questionnaire prior to its execution. Alternatively, or additionally, questionnaire rendering engine 130 may render questions during the execution of the questionnaire. The latter case provides for real-time customization of the questionnaire based on answers to previous questions, in addition customization based on entity-specific data. Real-time customization may also be provided in response to user configuration, such as a user selection of a preferred presentation format. Questionnaire content 110 may also include answers to display to questions posed (for example, multiple choice answers), and content related to the formatting and visual representation of a questionnaire.

As noted above, in one embodiment, the coding rules may be provided with reference to metatagged entity-specific data elements. For example, when creating the customized logic, such as display and branching rules for a given question or answer, a programmer can select from a list of existing metatagged entity-specific data elements, or the programmer can select from a list of all the components of the entity's record. Examples of metatagged items could include the patient's last height, weight, street name or visit frequency over the last tear. If a particular entity-specific datum is to be included in some form in a questionnaire (from simply being displayed to being a deciding factor for a branching rule), the questionnaire rendering engine retrieves the data prior to or at the time (i.e. dynamically, or in real time) the questionnaire is rendered.

In some embodiments, the rendering process may be achieved via an interface table that maps between metatags and the procedures that retrieve the data, as described above. In the example of SQL Server, the interface table may map the metatag to a stored procedure that actually retrieves the table or data element. It will be appreciated that the stored procedures may accept arguments for further customization of the query, for example, to filter certain data. Non-limiting examples of filter options include be ‘Most recent’, ‘Top 5’ or ‘Last Cholesterol result’. Since the interface table provides a link between the questionnaire rendering engine and the actual entity-specific data, the engine can be used with a given database by mapping the metatag to the fields in the interface table.

Additionally if a programmer wishes to add a new metatag that is to be attached to a query, the query can subsequently be added to the table and be made available. Advantageously, this may be achieved without complex programming steps and the programmer does not have to wait for a new release of the questionnaire rendering engine 130. That is to say, instead of updating all of the software associated with the questionnaire, only the metatags may be updated or added, thereby providing the questionnaire programmer with more options for entity-customization of a questionnaire without requiring a significant update of questionnaire software.

As shown in FIG. 1, questionnaire rendering engine 130 accepts, as input, coding rules that direct the execution of an entity-customized questionnaire and compiles a customized questionnaire based on data in the entity-specific record. Accordingly, questionnaire engine 130 provides the questions for the user to answer with the underlying order, display formatting, branching rules and permissions all bound to a given instance based on entity-specific data.

Once the user has completed the questionnaire, questionnaire output engine 150 stores the questionnaire results. In a non-limiting example, the results may be stored in one or more of the three example formats described below. The first format is coded into a single file (for example, XML) and can be used to easily read the data back into the display engine if desired.

Questionnaire output engine 150 may optionally create output in a second format that involves the creation of a human-readable report that can be viewed or stored (for example, in the entity-specific record). The output may optionally be automatically generated using rules provided by the customized logic. Suitable example rules include formatting rules, display order rules, content rules, and phrasing rules (for example, rules governing the manner in which the answer is generated in the output in a given linguistic context). For example, the human-readable report may be customized to be readable by a patient; in this case, the report may contain a disclaimer paragraph at the bottom, and may contain formatting which is designed to be aesthetically pleasing. In another example, the human-readable report may be customized for a doctor to read; in this case, the report may contain a list of prescribed medication, previous questionnaire results, or medical history, and may contain formatting which is designed to provide the information for the doctor in a clear and concise manner.

The following example illustrates the use of phrasing rules for customized questionnaire output. In this example, a question in a questionnaire is provided as:

“Select area where you feel pain: [checkbox list of body areas—neck, head, lower back, legs . . . ],”

In this example, Samantha is the patient's name, and this is tagged in the output string for generating the questionnaire output as follows:

“Samantha presented complaining of pain in the Head and Lower Back.”

The phrasing rules for generating this custom output is:

‘[PatientFirstName] presented complaining of pain in the [answer list bolded]’.

The third format may be obtained by optionally translating the questionnaire data into format suitable for data mining, such as a tabular or database format. The questionnaire data may be stored with additional metatags, for example, additional metatags that the questionnaire programmer included when the questionnaire was built. These additional metatags, which may be are different from (e.g. independent from) then the tags used to denote branching rules, may allow data to be compared across different questionnaires or databases. An example of such a metatag would be “Father's date of birth”. No matter how this question is asked, if this metatag is attached to the answer, as a “results metatag”, then a mining engine may be able to compare these data across different questionnaires or databases. The questionnaire output engine 150 can also optionally create a condensed synopsis of the full questionnaire for the use of different users.

Questionnaire output engine 150 may also optionally score the results of the questionnaire, provided that scoring rules and/or criteria are included. For example, scoring may be useful in providing or suggesting a diagnosis, or, for example, automating a pre-existing clinical scoring system for a particular condition. Each score result may also be given a metatag, thus enabling multiple score scales to be contained within the same questionnaire. The score result may also be stored into a table (which may be optionally accessed through the interface table). The score result, score metatag, and other optionally generated data (such as a maximum result and minimum result) may be stored, which allows for simple plotting of the result.

Questionnaire output engine 160 facilitates the extraction of such output results from the questionnaire data. Questionnaire output engine may also provide a statistical analysis of the questionnaire results, such as calculating a standard deviation for a number of similar numerical questions, for example, such that the entity's self-consistency in answering questions can be checked.

The following example illustrates a non-limiting example implementation of coding rules that are provided in an XML form of the customization logic 120:

```
      <QuestionItem Id=“103” Active=“true” HeightHint=“Auto”
Hint=“Help Text” Indented=“false” IsHeadered=“false”
ItemType=“RadioButton” Mandatory=“false” MTag=“”
Orientation=“Vertical” Text=“I feel tense or ‘wound up’”
AlternateText=“I feel tense or ‘wound up’” WidthHint=“Auto”
Wrap=“false”/>
      <conditionitem target=“[questionID]” source=“[metatag] or
[questionID]” operator=“[operator]” logiccondition=“[logic condition]”
value=“[value] or [tag]”/>
```

The XML section contains the ‘QuestionItem’ tag that indicates to the questionnaire rendering engine 130 that this is a new question.

The tag ‘conditionitem’ allows questionnaire rendering engine 130 to determine if this question should be rendered or not to the user.

The target attribute indicates which question is to be optionally rendered (the question itself and/or the output resulting from a user answering the question) using the unique identifier of each question.

The source attribute indicates either a different question (parent question) for the application of a test, or a metatag that will point to a particular entity-specific data element. The ‘operator’ attribute indicates the comparison condition (operator examples include: =, >, <, >=, <=, Not equal, Contained within, Not zero, =0).

The ‘logiccondition’ attribute indicates how multiple ‘conditionitem’ tags should be compared. This allows multiple condition items to be used on one question or output option. Examples of such a comparison are the logical conditions ‘and’, ‘or’ and ‘not’ between multiple ‘conditionitem’ tags for one question.

The ‘value’ attribute contains a value to which the result from the metatag or parent question is compared.

In the context of a medical questionnaire, the ‘conditionitem’ tag allows a patient data element or patient input to govern the flow and output of the questionnaire. As noted above, the [metatag] reference may be employed to indirectly reference the location of the patient data element through an interface table.

In an example of the above coding rules, where the questionnaire relates to a medical questionnaire, the coding rules are provided to specify that an answer option is to be provided in a given question if the patient is male and the patient is older than average age of all patients, or if the patient has shown any pervious heart condition, as per the patient record stored in a database.

An example of the coding rules for this question are as follows:

```
      <conditionitem target=“[AnswerID]” source=“Patient.Gender”
operator= “=” logiccondition=“AND” value=“Male”/>
      <conditionitem target=“[AnswerID]” source=“Patient
Age” operator=“>” logiccondition=“AND”
value=“Average.Age.Active.Patients”/>
      <conditionitem target=“[AnswerID]” source=“[QuestionID]”
operator=“=” logiccondition=“OR” value=“[response value]”/>
```

In the above coding rules, the metatag value Average.Age.Active.Patients generates a query on the database to obtain this value, and the value [response value] is a number corresponding to the heart condition response in the question referenced by [QuestionID].

It is noted that the source metatag could be a metatag that reaches outside of a given questionnaire and searches for that metatag in a previous questionnaire for the answer. For example, if the patient had responded about their heart condition in an intake assessment, then this different and previous questionnaire would prompt a search into this previous questionnaire. The data obtained from the previous questionnaire could, for example, be employed, as per the coding rules, to determine whether or not a given potential answer to a question would be shown during the questionnaire.

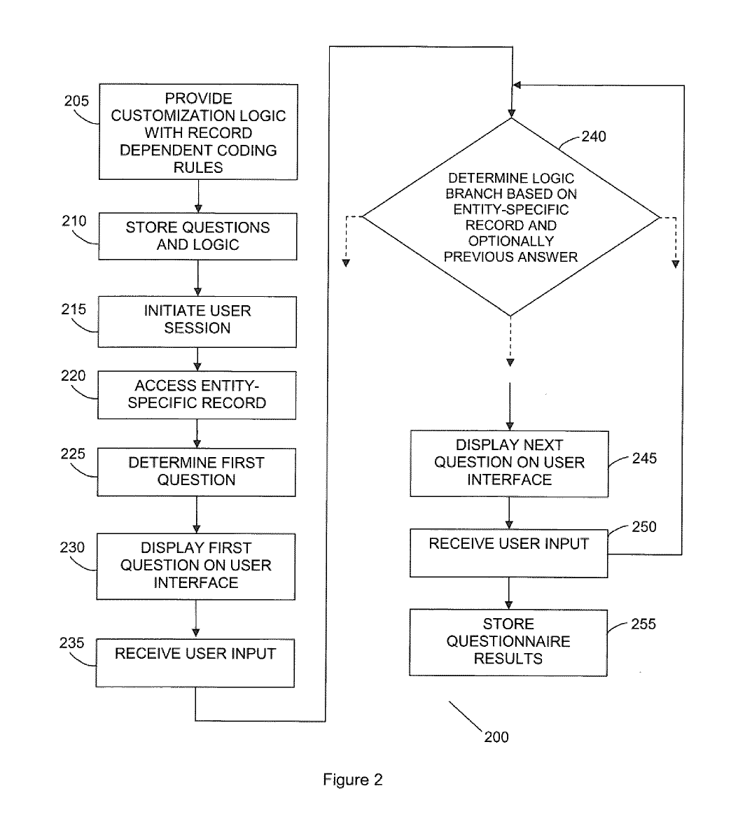

Referring to FIG. 2, a flow chart 200 is provided illustrating the logical flow of an entity-specific record driven questionnaire according to one embodiment. In step 205, questionnaire customization logic with a reference to entity-specific data is obtained, and the questionnaire content and customization logic are provided in the form of questionnaire coding rules and questions, respectively, as described above.

In step 210, the questionnaire content and coding rules are stored, respectively, as a collection of questions and logical flow rules that govern the customization of questions. In one embodiment, customized questions may be predetermined prior to executing the questionnaire by pre-processing the customized logic, questionnaire content, and entity-specific data. In another embodiment, the customized questionnaire may be dynamically generated during the execution of the questionnaire.

The questions may be stored as having embedded information obtained from the entity-specific record, such as the name of an entity, to support customization of the rendering of a particular question. This information may be directly embedded in the stored questions, or may be stored as links to the stored entity-specific record, which may be employed for dynamically rendering the customized questionnaire. This latter embodiment enables a common questionnaire question set and customization logic to be employed for multiple entities.

Following the initiation of a user session in step 215, a query may be made to access the entity-specific record in step 220 for receiving/obtaining the entity-specific data, for processing the customization logic. At this point, the specific ordering of questions may be determined if the customization logic pertains to the existing entity-specific record alone. If, however, the branching logic is also to be affected by the user's answers to questions during the questionnaire, the specific sequence of the questionnaire will be determined dynamically.

The first question of the questionnaire is determined in step 225 based on the entity-specific record and the stored customization logic (stored in step 210). This question is rendered in step 230, and the user input is responsively obtained in step 235.

In the example embodiment shown, the customization logic is employed to determine, at least in part, the remaining questions, according to the entity-specific record, and optionally further according to the user's answers to preceding questions, as noted above. In step 240, a specific logic branch is selected, and a subsequent question corresponding to the selected logical branch is rendered in step 245, for which user input is collected in step 250. This process is repeated for additional questions as dictated by the stored entity-customized customization logic, and the results of the questionnaire are stored for future use in step 255.

The aforementioned method may be implemented in any suitable hardware configuration, depending upon the environment in which the questionnaire is administered and the available equipment. All components of the system can be located in a single computer or distributed over a network (such as the Internet) with the user input and display interfaces residing in a client-side application and other system components residing on a remote computing system such as a server.

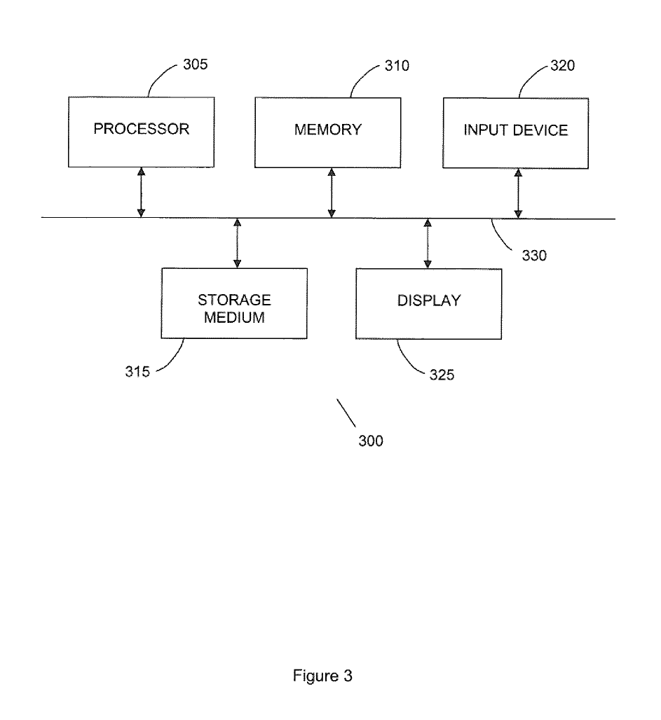

In one embodiment, the dynamic questionnaire system is implemented on a single computer or computing system 300, illustrated schematically in the example implementation shown in FIG. 3. The computer 300 can be a computing system or device such as a server, desktop computer, workstation, laptop computer, Personal Digital Assistant, or any other similar device having sufficient memory, processing capabilities, and input and output capabilities to implement the embodiments described herein. The device can be a dedicated device used specifically for implementing the present embodiments or a commercially available device programmed to implement the embodiments.

The example computing system 300 contains a processor 305, a memory 310, a storage medium 315, an input device 320, and a display 325, which are schematically shown as connected through bus 330. Although only one of each component is illustrated, any number of each component can be included. For example, computing system 300 may contain a number of different data storage media 315. Further, although bus 330 is depicted as a single connection between all of the components, it will be appreciated that the bus 330 may represent one or more circuits, devices or communication channels which link two or more of the components. For example, in personal computers, bus 330 is often provided on or as a motherboard.

Processor 305 executes steps of the aforementioned method under the direction of computer program code stored within computing system 300. Using techniques well known in the computer arts, such code is tangibly embodied within a computer program storage device accessible by the processor 305, e.g., within system memory 310 or on a computer readable storage medium 315 such as a hard disk or CDROM.

The methods can be implemented by any computing and/or programming method known in the art. For example, any number of computer programming languages, such as Java and C++, can be used. Furthermore, various programming approaches can be employed, such as functional or object oriented programming. The entity-specific records and/or generated questionnaires may be stored in the storage medium 315 or memory 305 and queried, for example, by a database or database server using conventional methods and communication protocols.

Display 325 presents questions of the dynamically generated questionnaire to the user, and response data are received via the input device 320. Although the display 325 is typically a monitor and the input device 320 is typically a keyboard and/or mouse, devices tailored to input or present particular data types can also be used. Input device examples include tablets or other touch screen devices, and medical instruments (such as, but not limited to, devices such as a blood pressure cuff, pulse oximeter and thermometer). For example, the input to the questionnaire may include data generated by a medical device, where the data is stored in a patient record and accessed by the system for the rendering of one or more customized questions. Display 325 can present the questions and related information by visual, auditory, or tactile means, or any combination of these formats.

Embodiments provided above may be implemented in a distributed or networked computer system in which the different software modules are executed by different computers or computing devices in order to maximize the efficiency of the questionnaire method. Further, embodiments provided above may be implemented in a client-server networked computer system whereby the entity-specific records and most of the questionnaire processing are conducted on a server, while interfaces to the system are provided at the client.

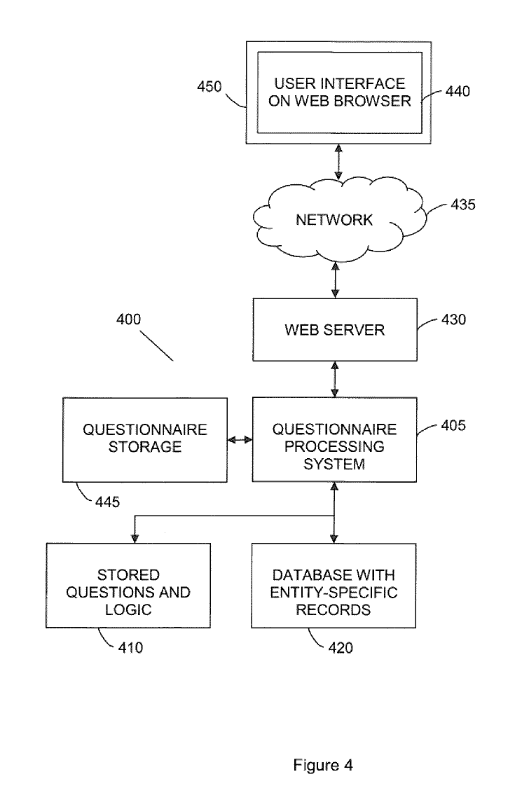

FIG. 4 schematically illustrates an example networked system 400 in which dynamic questionnaire processing system 405 performs the preceding method steps by employing stored questions and logic 410 and database 420 (containing entity-specific records). The questionnaire logic and content is first provided, specifying logical flow of questions, and specifying how branching logic and question rendering is influenced by entity-specific records stored in database 420, and the designed questionnaire is stored in a storage medium or memory as stored questions and entity-customized customization logic 410. Alternatively, user device 450 may itself be programmed with a questionnaire builder algorithm or application.

A given questionnaire is constructed, optionally in a dynamic fashion employing question-driven customization logic in addition to entity-specific record specific customization logic, by questionnaire processing system 405, which renders the dynamic questionnaire on user interface 440 during questionnaire execution. Questionnaire results are stored in questionnaire memory 445. While system 400 remotely processes and renders the questionnaire for display on user interface 440, it is to be understood that such steps may alternatively be performed on user device 450, provided that user device 450 is programmed accordingly.

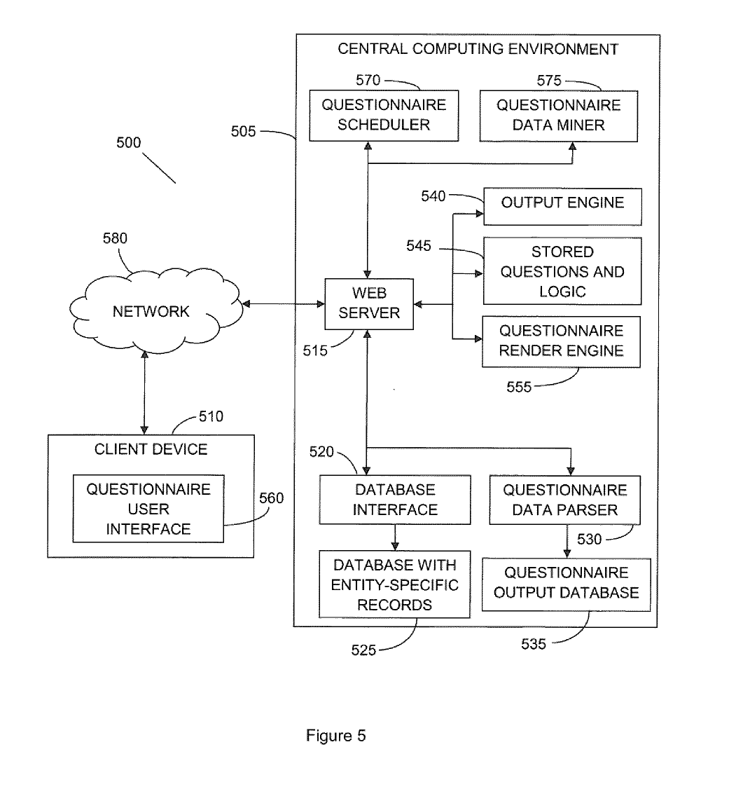

FIG. 5 illustrates an embodiment of a system 500 for generating and rendering dynamic record-driven questionnaires. System 500 shows a more detailed implementation of a client-server system whereby a user operates a client device 510 for completing a customized questionnaire. The questionnaire is remotely rendered by central computing system 505, where web server 515 supports communication with client device 510 over network 580.

Central computing system includes several modules, including web server 515, questionnaire rendering engine 555, stored questions and customization logic 545, output engine 540, database 525, and questionnaire output data 535. Questionnaire rendering engine 535 accesses stored questions and customized customization logic 545 for the rendering and delivery of questionnaires to client device 510. Client device 510 is programmed to provide a questionnaire user interface 560, for example, via a web browser as in FIG. 5.

System 500 includes a number of additional components that may be optionally included for additional analysis, functionality and/or interfacing. For example, system 500 may optionally further include questionnaire scheduler 570 for scheduling the delivery of a questionnaire to a user. The scheduler is a separate module that allows a programmer, designer or publisher of questionnaires to provide access to a user as they wish.

In one embodiment, the scheduler module 570 allows publication of the questionnaire based on two example methods: to one specific entity, or to a group of entities with some linking characteristic. The first method focuses on an individual entity, user or questionnaire responder. The act of publishing the questionnaire entails customizing an instance of the questionnaire template for a user, and making it available to them for execution.

Non-limiting examples of methods and criteria for publishing a questionnaire to a user or entity include: one time on a particular day (or immediately); on a specific day or days of the week (Thursday and Sunday); a number of days before an event (such as a visit of a patient with a selected provider); a number of days after an event; continuous publication, in which a blank questionnaire is immediately made available to the user after having completed a previous questionnaire; and use one of the branching metatags available in the questionnaire builder publish the when a condition is met (examples include: ‘when the patient turns 50’, ‘when it has been 6 months from their last visit’, ‘when a lab result has a certain value’).

The scheduler may also support the publishing of a questionnaire to a group of entities or users that have a certain characteristic. One embodiment uses the decision metatags available in the builder the questionnaire programmer to automatically schedule questionnaires to any user that fits these criteria. Examples would be ‘All patients with a high BMI”, “Patients who are smokers’, ‘Patients who are female and have elevated estrogen’. A separate application is executed once a day, for example at night, that can test each condition and publish to every patient that meets that condition. The patient may be notified (e.g. by E-mail or automated telephone call) that a questionnaire is waiting for them to fill out. This routine can also create reminders for any uncompleted questionnaires that have been published for more than a set number of days.

System 500 may also include questionnaire data miner module 575 for quantitatively mining questionnaire data 535 and/or client data 525. Data miner 575 provides a processing and an interface for analyzing the results of a single questionnaire or multiple questionnaires. Additionally, data miner 575, using the answer metatags published with the questionnaire builder 550, may be programmed to compare across databases (different clinics for example). The data miner may present result graphically, in a tabular format, in a plot, or just as text information.

In one embodiment, central computing system is programmed with user data interface 520 that provides a separation between the rendering engine, the scheduler and the output engine and the underlying database. Data interface 520 may provide an interface table, as described above, which allows the questionnaire system to be able be ported easily to another database that may contain very different types of data.

A similar translation interface may be provided for the storage of questionnaire output data, and is implemented in FIG. 5 as questionnaire data parser 530. Data parser 530 provides a separation between output engine 540 and stored questionnaire output data 535, enabling the convenient and ready interfacing of the questionnaire system with different output database formats for questionnaire data storage and archiving.

As described above in regard to database interface 520, questionnaire data parser 530 may include an interface table that is populated to map the data structure of a database for storing questionnaire output database 535 to metatags. Output engine 540 may employ embedded metatags for referencing questionnaire output data stored within questionnaire output database 535. The metatags may act as an abstract reference to questionnaire output data, that is to say, they reference questionnaire output data in a manner that does not depend on the implementation of the output data storage.

If desired, the underlying stored procedures for the outputting of questionnaire data may be updated to match the output database. As noted above, from a programmability standpoint and a portability standpoint, this affords a single point of contact between the entire questionnaire system and the questionnaire output database to which it is interfaced. Again, the software of the questionnaire engine does not have to change and new metatags can be added by either the questionnaire programmer or the developer of output engine 540.

It is to be understood that while system 500 is illustrated in a client-server architecture, system 500 may be readily adapted to other architectures, including, but not limited to, cloud computing systems, peer-to-peer network models, and an implementation in which all components reside on a single computing system as described above. Moreover, one or more of the system components residing in central computing environment may be alternatively provided remote from the central computing system. For example, any one of the output engine 540, questionnaire storage medium 545, and questionnaire render engine 555 may reside on client device 510.

Components of central computing system 505 may be provided in a separate remote computing system or device that is networked to central computing system 505, for example, through web server 515. In one embodiment, questionnaire scheduler 570 and/or questionnaire miner 575 may reside on a separate remote computing system. Alternatively, these components may reside on central computing system 505, but input to such components is provided by a separate user device, such as an additional web browser running a web-based application that is dedicated to questionnaire scheduling and/or questionnaire mining.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A computer implemented method of generating a customized questionnaire, wherein the customized questionnaire is customized for an entity, the method comprising the steps of:
retrieving a set of questions;
retrieving customization logic associated with the customized questionnaire for customizing the set of questions according to entity-specific data, wherein the customization logic comprises a reference for obtaining the entity-specific data from a database;
employing the reference to generate a query for obtaining the entity-specific data from the database;
receiving the entity-specific data in response to the query; and
processing the customization logic and the entity specific data to render the customized questionnaire.

2. The method according to claim 1 wherein the customization logic comprises branching logic associated with the entity-specific data, and wherein the step of rendering the customized questionnaire comprises determining a presentation order of at least a subset of the set of questions according to the branching logic.

3. The method according to claim 2 wherein the branching logic is further dependent on a response to at least one question of the set of questions.

4. The method according to claim 1 wherein the step of rendering the customized questionnaire comprises determining, based on the entity-specific data, which questions in the set of questions are included in the customized questionnaire.

5. The method according to claim 1 wherein the step of rendering the customized questionnaire according to the customization logic comprises comparing a reference value and the entity-specific data.

6. The method according to claim 1 wherein the step of rendering the customized questionnaire is performed prior to presenting the customized questionnaire.

7. The method according to claim 1 wherein the customized questionnaire is dynamically rendered while presenting the customized questionnaire.

8. The method according to claim 1 further comprising the step of obtaining interface data associated with the reference for generating a database-specific query to obtain the entity-specific data from the database.

9. The method according to claim 8 wherein the interface data associates the reference with one of a database field and a stored procedure for obtaining the entity-specific data.

10. The method according to claim 9 wherein the reference comprises a metatag, and wherein said step of generating the query comprises determining the query according to a metatag interface, wherein the metatag interface provides instructions for transforming the metatag into the query.

11. The method according to claim 10 wherein the metatag interface comprises a table having rows, wherein each row maps a metatag to one of a database field and a stored procedure.

12. The method according to claim 1 wherein the customization logic is provided as a set of coding rules.

13. The method according to claim 12 wherein the coding rules are coded in a markup language.

14. The method according to claim 13 wherein the coding rules are coded in Extensible Markup Language (XML).

15. The method according to claim 1 wherein at least one question in the set of questions comprises a set of selectable answers, and wherein the customization logic comprises answer selection logic, wherein the step of rendering the customized questionnaire comprises determining a subset of the selectable answers to present, wherein the subset of the selectable answers is based on the answer selection logic and the entity-specific data.

16. The method according to claim 1 wherein the customization logic comprises scheduling logic for determining when the customized questionnaire is to be published to a user, wherein the method comprises the step of publishing the customized questionnaire to the user according to the scheduling logic.

17. The method according to claim 16 wherein the scheduling logic determines when the customized questionnaire is published to the user based on one or more of: a particular time of day, a specific day or group of days of a week, a number of days before or after an event, continuous publication, and the entity specific data.

18. The method according to claim 16 wherein the scheduling logic determines when the customized questionnaire is published to the user based on answers provided in a previously completed questionnaire.

19. The method according to claim 16 wherein the query returns user data comprising user contact information, and wherein the method further comprises notifying the user that the customized questionnaire has been published.

20. The method according to claim 1 wherein the customization logic comprises formatting logic for determining a presentation format of the customized questionnaire according to the entity-specific data.

21. The method according to claim 20 wherein said formatting logic determines one or more of a font and font size according to the entity-specific data.

22. The method according to claim 1 wherein the set of questions includes questions from a first questionnaire and questions from one or more additional questionnaires, and wherein the customization logic is configured to include one or more questions from the additional questionnaires when rendering the customized questionnaire, according to responses from one or more questions from the first questionnaire and/or according to the entity-specific data.

23. The method according to claim 1 wherein the customization logic includes permission logic for determining whether or not to provide access to one or more questions of the set of questions according to an identity of the entity or a user class of the entity.

24. The method according to claim 1 wherein the customization logic comprises output logic for storing results of the customized questionnaire according to the entity-specific data, wherein the method further comprises storing questionnaire results according to the output logic.

25. The method according to claim 24 wherein the output logic comprises formatting instructions for storing the questionnaire results in a human-readable report according to the entity-specific data, and wherein the method further comprises storing the questionnaire results according to the formatting instructions.

26. The method according to claim 24 wherein the output logic comprises instructions for storing the questionnaire results format suitable for data mining.

27. The method according to claim 26 further comprising storing the questionnaire results with results metatags, wherein the results metatags are independent of the customized questionnaire and allow collection and comparison of results between a plurality of questionnaires.

28. The method according to claim 24 wherein the output logic comprises scoring rules, and wherein the method further comprises scoring questionnaire results according to the scoring rules.

29. The method according to claim 28 wherein the output logic further comprises instructions for storing scores with score metatags, wherein said score metatags are independent of the customized questionnaire and allow collection and comparison of scores between a plurality of questionnaires.

30. The method according to claim 1 wherein the entity-specific data comprises medical data.

31. The method according to claim 1 wherein the customization logic is further configured to obtaining additional entity-specific data from an additional data source associated with the entity, the method further comprising obtaining the additional entity-specific specific data.

32. The method according to claim 31 wherein the additional data source includes one or more of location-based data, and social-media based data associated with the entity.

33. The method according to claim 31 wherein the additional data source is accessible through a computing device associated with the entity.

34. A computer readable medium storing computer executable instructions for causing a computer to perform a method of generating a customized questionnaire, wherein the customized questionnaire is customized for an entity, comprising the steps of:
retrieving a set of questions;
retrieving customization logic associated with the customized questionnaire for customizing the set of questions according to entity-specific data, wherein the customization logic comprises a reference for obtaining the entity-specific data from a database;
employing the reference to generate a query for obtaining the entity-specific data from the database;
receiving the entity-specific data in response to the query; and
processing the customization logic and the entity specific data to render the customized questionnaire.

35. A system for providing a customized questionnaire, said system comprising:
a storage device comprising a set of questions;
one or more processors; and
memory coupled to the one or more processors, the memory storing instructions including customization logic associated with the customized questionnaire for customizing the set of questions according to entity-specific data, wherein the customization logic comprises a reference for obtaining the entity-specific data from a database, and wherein the instructions, when executed by the one or more processors, cause the one or more processors to perform operations comprising:
retrieving the set of questions from the storage device;
employing the reference to generate a query for obtaining the entity-specific data from the database;
receiving the entity-specific data in response to the query; and
processing the customization logic and the entity-specific data to render the customized questionnaire.

36. The system according to claim 35 wherein a memory or storage device coupled to the one or more processors further comprises interface data associated with the reference for generating a database-specific query to obtain the entity-specific data from the database.

37. The system according to claim 36 wherein the interface data associates the reference with one of a database field and a stored procedure for obtaining the entity-specific data.

38. The system according to claim 36 wherein the reference comprises a metatag.

39. The system according to claim 36 further comprising the database.

40. A system for providing a customized questionnaire, said system comprising:
a storage device comprising a set of questions;
a processor; and
a memory coupled with the processor, the memory comprising a computer readable medium having a questionnaire rendering engine embodied therein, said questionnaire rendering engine comprising customization logic for the customization of the customized questionnaire according to entity-specific data.
